(19) United States
(12) Patent Application Publication
(10) Pub. No.: US 2013/0037063 A1
(43) Pub. Date: Feb. 14, 2013

(54) MATTRESS SANITATION SYSTEM

(71) Applicant: Steven King, Seminole, FL (US)

(72) Inventor: Steven King, Seminole, FL (US)

(21) Appl. No.: 13/206,102

(22) Filed: Aug. 9, 2011

(51) Int. Cl. B08B 3/10; B08B 3/14

(52) U.S. Cl. 134/31; 134/200; 134/84; 134/88; 134/109; 134/105; 134/56 R

(57) ABSTRACT

A mobile mattress sanitizing and cleaning system. A cleaning chamber and drying chamber may be located within the body of truck which may also carry a water supply and steam generator. The cleaning and drying chambers are dimensioned and configured to receive a mattress therein, and may be separate or combined. The mattress is steam cleaned in the cleaning chamber and air dried in the drying chamber. The cleaning and drying chambers may face the rear of the truck to facilitate loading and may be oriented such that mattresses stand on edge when being cleaned and dried. The system may include a water purifier. Drying may be conducted by blowers mounted to the drying chamber. Drying air may be heated.

### FIELD OF THE INVENTION

The present invention relates to a sanitation system particularly adapted for treating bed mattresses and the like, and more particularly, to a mobile or motorized sanitation for this purpose.

### BACKGROUND OF THE INVENTION

Mattresses used for sleeping become permeated with contaminants over time and with use, which are very difficult to remove. Small particles of dead skin, mites, residues of body fluids, and other contaminants are inevitably encountered. Ordinary consumer cleaning equipment such as vacuum cleaners, spray disinfectants, and others are not adequate for proper cleaning of mattresses. Moreover, mattresses are large and, particular in light of their tendency to slump when placed on edge, are difficult for people to maneuver. Yet a need for cleaning mattresses remains. It follows that there is a need for apparatus particularly suitable for cleaning and sanitizing mattresses.

### SUMMARY OF THE INVENTION

The present invention provides apparatus and method for cleaning and sanitizing mattresses. The apparatus includes a chamber for subjecting mattresses to steam and a second chamber for drying treated mattresses. These chambers are carried aboard a truck. Support equipment such as a steam generator, water supply serving the steam generator, and a water purifier are also carried aboard the truck.

The steam chamber and drying chamber are each just larger than a mattress, so that a mattress is not only received therein, but is constrained to stand in an erect orientation. Steam from the steam generator is conducted to the steam chamber, and is directed by a suitable manifold to impinge upon the mattress so as to assure full and effective permeation of the mattress. The mattress may be removed from the steam chamber and placed within the drying chamber, where blowers circulate ambient air so as to dry the mattress.

The invention may be regarded as a method of cleaning a mattress. The method emphasizes the mobile aspect of the apparatus, which makes the method practical. Because of the size, weight, and tendency to slump, it becomes desirable to minimize handling and transport of a mattress. Providing a motor vehicle such as a truck which is self-contained allows for practical, expeditious cleaning and sanitizing of mattresses at most locales. Availability of transport vehicles for transporting mattresses, a suitable place within a building or its surrounds to clean a mattress, and an independent source of water are all rendered unnecessary. Because of the practicality of the apparatus and its use, cleaning of mattresses, especially in commercial and institutional settings, becomes sufficiently practical so as to offer such a service on a commercial basis.

It is an object of the invention to provide a mattress cleaning and sanitizing apparatus which is effective in operation.

Another object of the invention is that the mattress cleaning and sanitizing apparatus be mobile, so that it may be driven to the premises containing mattresses to be cleaned.

A further object of the invention is to utilize steam for cleaning and sanitizing.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a truck adapted to carry apparatus for cleaning and sanitizing mattresses, according to at least one aspect of the invention, and is shown broken away to reveal internal detail.

FIG. 2 is a diagrammatic top plan view of a truck adapted to carry apparatus for cleaning and sanitizing mattresses.

FIG. 3 is a side view taken along line 3-3 of FIG. 2.

FIG. 4 is a perspective view of a sanitizing and drying chamber according to at least one aspect of the invention.

FIG. 5 is an environmental perspective view of the sanitizing and drying chamber of FIG. 4, shown from a different angle, broken away to reveal internal detail, and drawn to reduced scale.

FIG. 6 is a block diagram of energy consuming components of sanitizing and drying chambers of FIG. 1.

FIG. 7 is a block diagram of energy consuming components of a combined sanitizing and drying chamber, according to at least one aspect of the invention.

FIG. 8 is a block diagram showing steps in summarized form of a method of using the novel apparatus.

### DETAILED DESCRIPTION

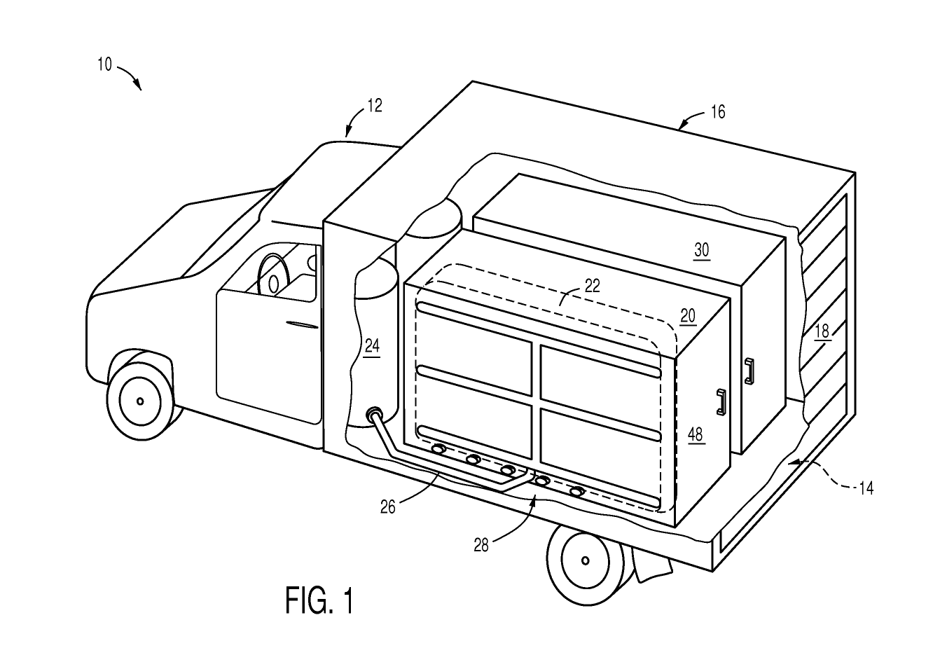

Referring first to FIG. 1, according to at least one aspect of the invention, an apparatus 10 for cleaning and sanitizing mattresses may comprise a motor vehicle such as a truck 12 having a load bed 14 contained within a body 16. The truck 12 may be conventional, having an engine, drive train, a cabin 13 containing a seat for the operator and operator controls, suspension, chassis (not separately shown) and other conventional amenities enabling the truck 12 to be operated by a human driver (not shown) and loads borne on the truck 12 transported on public roads and highways. The truck 12 may have a lift gate (not shown) to assist in loading and unloading mattresses. The body 16 encloses the load bed 14 so as to shelter components of the apparatus 10, and may have a roll-up door 18 disposed at the rear of the body 16, although of course other types of closures may be utilized if desired.

A sanitizing chamber 20 may be disposed on the load bed 14 and more particularly, within the body 16. The sanitizing chamber 20 comprises a housing having walls defining an open interior, which walls and interior are dimensioned and configured to receive a mattress 22 in close cooperation therein. The sanitizing chamber 20 may have walls of nominal thickness, made from stainless steel or aluminum. The sanitizing chamber 20 may, when oriented as shown in FIG. 1, have exemplary dimensions such as length of twelve feet, height of eight feet, and depth of three feet.

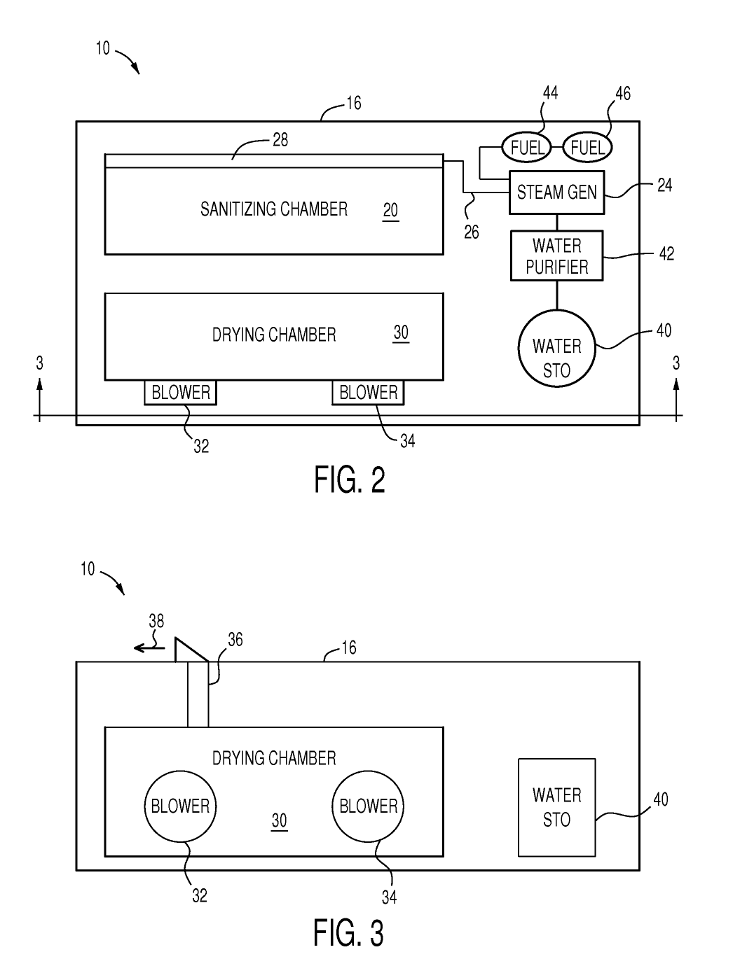

A steam generator 24 may be located within the body 16 and may generate steam for use in cleaning and sanitizing mattresses. The steam generator 24 may be of the type which burns fuel and boils water for example. Optionally, a steam dryer (not shown) may be provided to assure that only dry steam be delivered to the mattress 22. Dry steam is regarded as a desirable sanitizing and cleaning agent since it is entirely non-toxic, yet highly effective against insects, mites, bacteria, and other biological pests being eliminated in the sanitizing and cleaning process. The apparatus 10 may include a fuel supply located on the motor vehicle 12 and disposed to supply fuel to the steam generator 24. The fuel supply may comprise propane tanks 44, 46 (see FIG. 2) for example.

A conduit system represented by a conduit 26 and including a manifold 28 is disposed to conduct generated steam to the interior of the sanitizing chamber. The manifold 28 may be disposed to discharge generated steam from the conduit system only over the large face the mattress 22 being cleaned, and substantially over the full extent of the large face of the mattress 22. This assures that steam passes through the thinnest dimension of the mattress 22, thereby not losing its pressure and flow rate as would occur if for example the direction of steam flow were along the length of the mattress 22.

The apparatus 10 may comprise a drying chamber 30 disposed on the load bed, again within the body 16. Just like the sanitizing chamber 20, the drying chamber 30 comprises a housing having walls defining an open interior, which walls and interior are dimensioned and configured to receive a mattress such as the mattress 22 in close cooperation therein.

Referring also to FIGS. 2 and 3, the drying chamber 30 may have two blowers 32, 34 disposed to force ambient air into the drying chamber 30 and over or through a mattress such as the mattress 22. This evacuates water which may have condensed from the steam supplied to effect sanitizing and cleaning. The drying chamber 30 may be served by an exhaust conduit 36 which communicates between the interior of the drying chamber 30 and ambient air such as the air outside the body 16. Direction of discharged vapors from the drying chamber 30 is indicated by an arrow 38.

The apparatus 10 may include a water storage facility such as a tank 40 disposed to supply water to the steam generator 24. The water handling system shown representatively in FIG. 2 in lines may include a water purifying facility 42 disposed to purify water being supplied to the steam generator. The water purifying facility 42 may include any desired type of water purifying apparatus, such as a selectively permeable membrane or other type of filter (none shown) for example.

Referring to FIG. 1, it will be seen that the sanitizing chamber 20 is disposed such that the mattress 22 placed therein stands on edge. A consequence of this orientation is that when occupying the interior of the sanitizing chamber, the mattress 22 occupies only a limited or minimal portion of the footprint, or floor space, of the body 16. Also, the sanitizing chamber 20 has a door 48 which faces the rear of the body 16. With the roll-up door opening the body 16 to the rear of the truck 12, this facilitates efficient loading of the mattress 22 from the rear of the body 16 directly into the sanitizing chamber 20 by moving the mattress 22 in a horizontal motion along the floor of the body 16. Also, the erect posture of the mattress 22 as depicted in FIG. 1 is regarded as providing the most comfortable and wieldy positioning from the standpoint of a person charged with loading the mattress 22 into the sanitizing chamber 20 by hand. The drying chamber 30 is similarly oriented so as to enjoy the same benefits when loading and unloading mattresses.

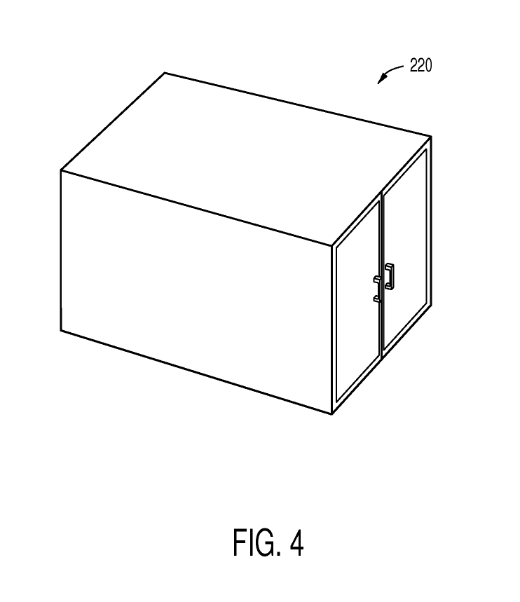

According to a further aspect of the invention, the cleaning and sanitizing chambers may be combined as a common chamber. This is shown in FIG. 4, wherein a combined sanitizing and drying chamber 220 is depicted. The combined sanitizing and drying chamber 220 may be for example about twenty-two feet long, nine to ten feet long, and five feet wide. It will be appreciated that these dimensions, or the actually selected dimensions, will accommodate furniture such as recliners, sofas, chairs, and other forms of upholstered furniture. Hence it will be understood that description of the invention as applying to mattresses is done so only as a convenience, and that any of the novel principles may be applied to cleaning of furniture elements other than mattresses.

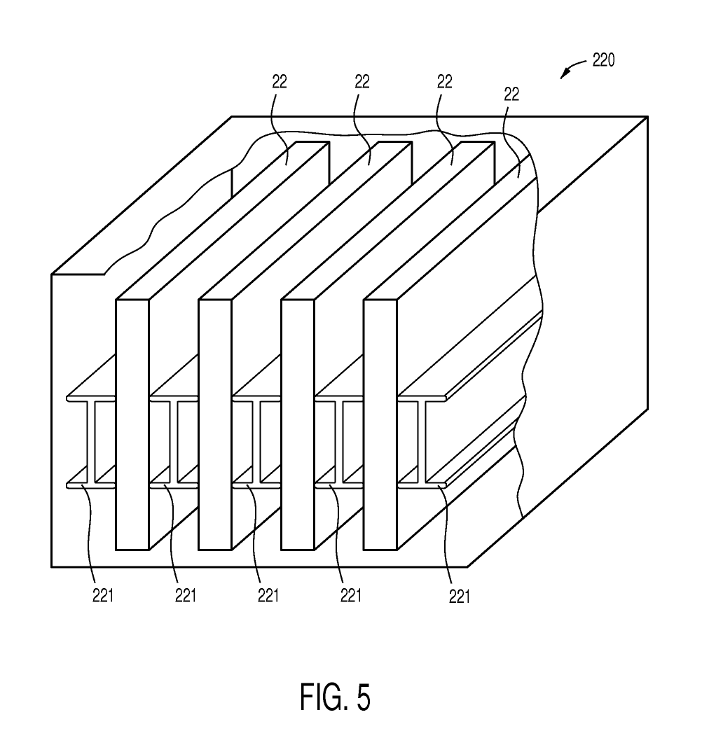

According to a further aspect of the invention, shown in FIG. 5, the combined sanitizing and drying chamber 220 may be organized by organizers such as partitions or spacers 221 which hold plural mattresses 22 upright and spaced apart for simultaneous cleaning. The spacers 221 may be devices comprising skeletal frames having rigidity and defining open passages between the various members of the skeletal frame so that air and vapor currents passing through the combined sanitizing and drying chamber 220 are not unduly obstructed such that cleaning and drying may proceed.

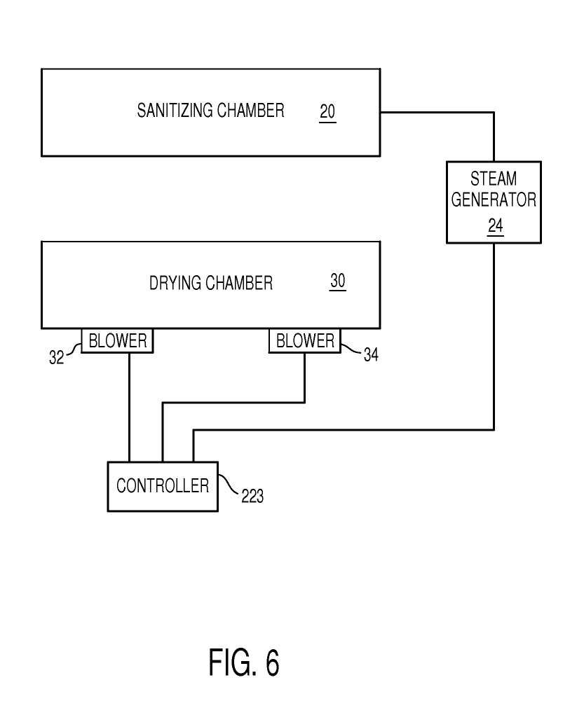

Referring to FIG. 6, where steaming and drying are performed in separate sanitizing chamber 20 and drying chamber 30, electronic controls may be provided to enable the operator to select a cleaning sequence wherein steam is used for a predetermined time interval, after which a drying operation is initiated automatically. A master controller 223 may be provided to operate necessary solenoid valves, motors, and other electrical components (not individually shown) which enable the steam generator 24 and the blowers 32, 34 to operate. The steam generator 24 may be of conventional type having a burner, a water inlet valve, and a steam outlet valve (not individually shown). These control components and the electric motors of the blowers 32, 34 may be controlled by relays and other conventional controls which may be placed under the control of an electrical or electronic timer and master switch contained within the master controller 223. The master controller 223 will be understood to comprise all necessary conventional control elements for effecting the sequence of operation set forth herein, contained within a single suitable enclosure or otherwise concentrated within a centralized location.

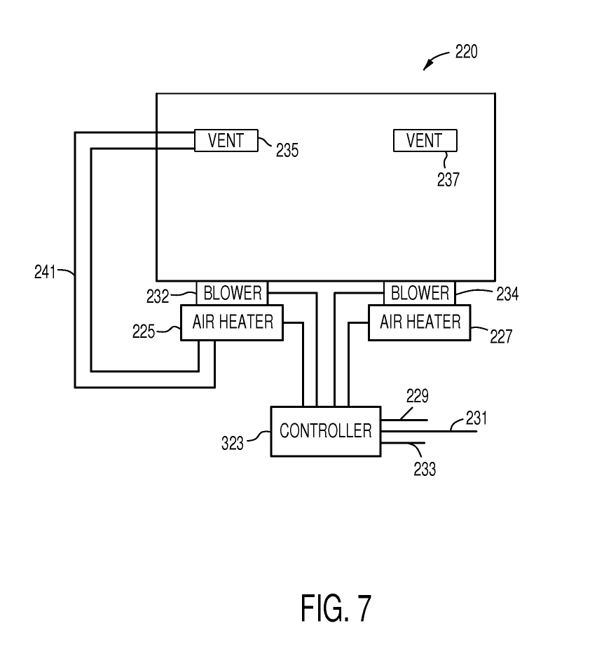

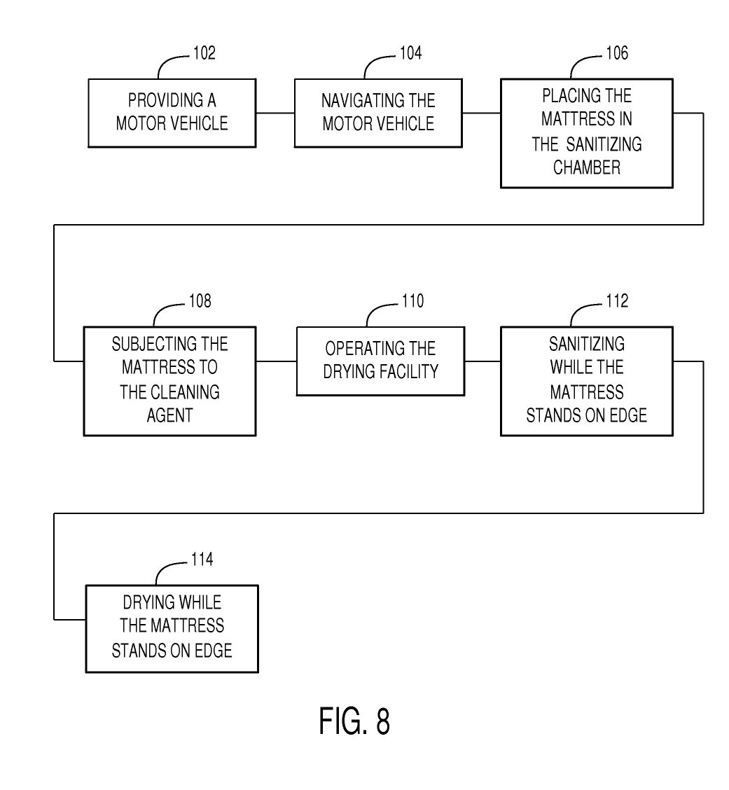

The combined sanitizing and drying chamber 220 seen in FIG. 5 may have the components and control scheme explained with reference to FIG. 7. The combined sanitizing and drying chamber 220 may be provided with blowers 232, 234 which may be similar in structure and function to the blowers 32, 34. Air heaters 225, 227, which may have electrical or fuel burning heating apparatus (not individually shown) as well as the blowers 232, 234 may be under the control of a master controller 323. The air heaters 225, 227 may heat air to expedite drying over that which would result from using untreated ambient air and to further sanitize the article or articles being treated. The master controller 323 may be similar in operation to the master controller 223, except adapted for operative control of the different numbers or types of powered devices being controlled.

The controller 323 may have a control conductor 229 extending to a steam generator such as the steam generator 24, a control conductor 231 extending to dampers (not shown) which may be provided to selectively open and close one or both vents 235, 237 which may be arranged to discharged air from the combined sanitizing and drying chamber 220 to the ambient air, and a power conductor 233 extending to the battery (not shown) of the vehicle associated with the combined sanitizing and drying chamber 220.

Additional ducting 241, which will be understood to include necessary dampers (not shown) may be provided to cause drying air from the combined sanitizing and drying chamber 220 to be partly discharged to the ambient environment and partly recirculated, where desired.

The apparatus 10 may be utilized to implement a method of cleaning and sanitizing mattresses such as the mattress 22. The method is sufficiently efficient as to warrant practice on a commercial basis. It would particularly be advantageous for hotels, motels, and institutions having a significant number of beds, such as dormitories and infirmaries. The method may be practiced such that the vehicle provided with the apparatus described herein serves itself. For example, cruise ships may have a facility as described herein, albeit not on a road going vehicular chassis or vehicle.

As summarized in FIG. 4, the method 100 may comprise:

a step 102 of providing a motor vehicle such as the motor vehicle 12, which is fitted with a sanitizing chamber which is dimensioned and configured to receive a mattress in close cooperation therein, and a system disposed to dispense a cleaning and sanitizing agent to a mattress which has been placed within the sanitizing chamber;

a step 104 of navigating the motor vehicle to premises having at least one mattress;

a step 106 of removing the mattress from the premises and placing the mattress in the sanitizing chamber of the motor vehicle;

a step 108 of subjecting the mattress to the cleaning and sanitizing agent aboard the motor vehicle; and

a step 110 of operating the drying facility to evacuate the cleaning and sanitizing agent from the mattress while the mattress is aboard the motor vehicle.

Optionally and preferably, the method 100 may comprise a further step 112 of sanitizing the mattress while the mattress stands on edge, and a still further step 114 of drying the mattress while the mattress stands on edge.

The present invention is susceptible to modifications and variations which may be introduced thereto without departing from the inventive concepts. For example, although description of the novel system is based on the truck 12, it will be recognized that the apparatus 10 may be distributed throughout plural vehicles. For example, the sanitizing, cleaning, and drying elements may be located in one vehicle, with support elements such as the steam generator 24, water storage facility, water purifying facility 42, and propane tanks 44, 46 carried aboard a second vehicle (this option is not shown). The distribution of elements of the novel system in plural vehicles could of course be arranged in other ways.

Also, the motor vehicle carrying the apparatus 10 may be a drawn vehicle such as a trailer, and not literally include an engine and power train (this option is not shown).

The apparatus 10 may be modified such that the sanitizing chamber 20 and drying chamber 30 abut one another or are combined into one chamber (these options are not shown).

The sanitizing and cleaning system may dispense agents other than or in addition to steam. Such agents could include bacteriocidal agents, oxidizing agents, perfumes, solvents, and other agents other than or in addition to water.

The water purifying facility 42 may be eliminated where water of adequate quality, such as distilled water, is available.

The water storage facility could be eliminated in favor of or supplemented by a connection such as a hose bib (not shown).

Where presented herein, features will be understood to be complete and operable, including all necessary or advisable components regardless of whether explicitly shown and described. For example, the master controllers 223, 323 will be understood to include operable connection to electrical power, pneumatic power, or other power source (not shown). The motor vehicle such as the truck 12 may be equipped with an onboard generator or a receptacle enabling connection by extension cord to building AC electrical power or both (none shown). The conduit system indicated in solid lines in FIG. 2 may include known plumbing components such as valves, quick connectors, backflow preventers, and the like (none shown). The conduit system may utilize rigid conduits, flexible conduits, or both.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

I claim:

1. Apparatus for cleaning and sanitizing mattresses, comprising:
a motor vehicle having a load bed;
a sanitizing chamber disposed on the load bed, which is dimensioned and configured to receive a mattress in close cooperation therein; and
a steam generator disposed to generate steam, and a conduit system disposed to conduct generated steam to the interior of the sanitizing chamber.

2. The apparatus of claim 1, further comprising a drying chamber disposed on the load bed, which is dimensioned and configured to receive a mattress in close cooperation therein.

3. The apparatus of claim 2, further comprising at least one blower adapted to force ambient air over a mattress within the drying chamber.

4. The apparatus of claim 2, further comprising an exhaust conduit communicating between the interior of the drying chamber and ambient air.

5. The apparatus of claim 1, further comprising a water storage facility disposed to supply water to the steam generator.

6. The apparatus of claim 1, further comprising a water purifying facility disposed to purify water being supplied to the steam generator.

7. The apparatus of claim 1, further comprising a fuel supply located on the motor vehicle and disposed to supply fuel to the steam generator.

8. The apparatus of claim 1, wherein the sanitizing chamber is disposed such that a mattress placed therein stands on edge.

9. The apparatus of claim 1, wherein the drying chamber is disposed such that a mattress placed therein stands on edge.

10. The apparatus of claim 1, wherein the motor vehicle is a truck having a cabin and a body which encloses the load bed.

11. The apparatus of claim 10, wherein the body and the sanitizing chamber both open toward the rear of the truck, so that mattresses may be loaded into and removed from the sanitizing chamber by horizontal movement of the mattresses from the rear of the truck.

12. The apparatus of claim 10, further comprising a drying chamber disposed on the load bed, which is dimensioned and configured to receive a mattress in close cooperation therein, wherein the drying chamber is oriented such that a mattress placed therein stands on edge.

13. The apparatus of claim 12, wherein the body and the drying chamber both open toward the rear of the truck, so that mattresses may be loaded into and removed from the drying chamber by horizontal movement of the mattresses from the rear of the truck.

14. The apparatus of claim 1, further comprising a source of heated air disposed to discharge heated air into the sanitizing chamber, whereby the sanitizing chamber also serves as a drying chamber.

15. The apparatus of claim 1, further comprising a steam manifold disposed to discharge generated steam from the conduit system only over the large face of a large face of a mattress being cleaned, and substantially over the full extent of the large face of the mattress.

16. The apparatus of claim 2, further comprising controls disposed to effect a cleaning sequence wherein steam is used for a predetermined time interval, after which a drying operation is initiated automatically.

17. The apparatus of claim 14, further comprising controls disposed to effect a cleaning sequence wherein steam is used for a predetermined time interval, after which a drying operation is initiated automatically.

18. The apparatus of claim 14, wherein the sanitizing chamber is about twenty-two feet long, nine to ten feet long, and five feet wide.

19. The apparatus of claim 14, further comprising an organizer disposed to support plural mattresses upright and spaced apart for simultaneous cleaning thereof.

20. A method of cleaning and sanitizing mattresses, comprising the steps of:
providing a motor vehicle fitted with a sanitizing chamber which is dimensioned and configured to receive a mattress in close cooperation therein, and a system disposed to dispense a cleaning and sanitizing agent to a mattress which has been placed within the sanitizing chamber;
placing the mattress in the sanitizing chamber of the motor vehicle; and
subjecting the mattress to the cleaning and sanitizing agent aboard the motor vehicle.

21. The method of claim 20, comprising the further steps of:
providing a drying facility disposed to evacuate the cleaning and sanitizing agent from the mattress; and
operating the drying facility to evacuate the cleaning and sanitizing agent from the mattress while the mattress is aboard the motor vehicle.

22. The method of claim 20, comprising the further step of navigating the motor vehicle to premises having at least one mattress.
